(19) United States
(12) Patent Application Publication
(10) Pub. No.: US 2023/0173783 A1
(43) Pub. Date: Jun. 8, 2023

(54) PLOTTER, RELATED UNIT, AND METHOD FOR CREASING AND CUTTING SHEETS OF PACKAGING MATERIAL

(71) Applicant: LOGICSISTEMI S.r.l., Fara Gera D Adda (BG) (IT)

(72) Inventor: Matteo Redaelli, Treviglio (BG) (IT)

(21) Appl. No.: 18/060,146

(22) Filed: Nov. 30, 2022

(30) Foreign Application Priority Data
Dec. 3, 2021 (IT) 102021000030686

(51) Int. Cl. B31F 1/10; B31B 50/14

(52) U.S. Cl. CPC B31F 1/10; B31B 50/14

(57) ABSTRACT

The present disclosure relates to a plotter for creasing and cutting a sheet of packaging material, the plotter comprising a work surface and a tool-holder head movable on the work surface according to a pre-set creasing pattern and a pre-set cutting pattern. The plotter comprises a creasing unit, configured to be mounted on the tool-holder head, which includes an extruder, configured to extrude at least one profile onto the work surface according to the pre-set creasing pattern, and a creasing tool provided with a groove adapted to couple, in use, with the at least one profile extruded by the extruder thereby obtaining a corresponding folding line on the sheet of packaging material. The invention also relates to a creasing unit and to a creasing method.

### CROSS-REFERENCES TO RELATED APPLICATIONS

This application claims the benefit of Italian Patent Application No. 102021000030686, filed Dec. 3, 2021, and which is hereby incorporated by reference.

### FIELD OF THE INVENTION

The present invention relates generally to the technical field of packaging production. More particularly, the invention relates to a plotter for creasing and cutting sheets of packaging material, such as flat or corrugated cardboard, card, and the like. The invention also relates to a creasing unit and a creasing method.

### BACKGROUND

Packaging, in particular cardboard boxes, is used in a wide range of product sectors, from food to entertainment, from mechanics to furnishings. In fact, packaging protects the product contained therein, facilitating its transport and preserving its integrity.

With particular reference to cardboard boxes, the process for their production involves two fundamental steps, namely cutting the desired shape of a box on a sheet of cardboard and creasing, which comprises producing one or more grooves or fold lines on the sheet of cardboard to facilitate folding of the sheet of cardboard, thereby obtaining the box of the desired shape. Creasing substantially comprises a “yielding” of the fibres of the cardboard, so that they can better withstand the folding operation.

Among the most widespread methods for producing packaging is die cutting, which is based on the use of a die cutter. The die cutter is a device formed of a steel blade with a sharp upper profile, also called a cutting blade, which reproduces, on a wooden table, the desired shape of a packaging. To obtain the folding lines, the die cutter further comprises a blade with a rounded upper profile, also called a creasing blade, which causes, in the appropriate position, a compression and/or yielding of the material of which the packaging is made, for example cardboard, thereby allowing subsequent folding along a given line.

Once the die cutter has been produced, it is inserted into a machine that, opening and closing alternately with the insertion of the sheet of material to be die cut, allows a complete cut to be made, thereby obtaining the packaging of the desired shape. The sheet of material to be die cut is positioned between the die cutter and a counter-plate, onto which channels are preferably provided at the creasing blade, which allow the folding line to be improved and prevent breakage of the surface of the cardboard along the folding line. The breakage would be detrimental to the quality of the packaging obtained, for example a cardboard box. After a batch of cardboard boxes has been produced, the die cutter is protected against damage and stored until the customer requests the production of a new batch of the same packaging.

Although the die cutting method has the great advantage of allowing identical and precise cuts to be made, it also has the drawback of requiring a die cutter to be made for each type of packaging to be produced. Therefore, this method is very onerous, both in terms of operations and of costs, and hence difficult to apply to the production of short runs of packaging or samples of customized boxes, i.e., designed on demand and based on the customer's needs.

In fact, over the last twenty years, with market evolution and the advent of numerically controlled production devices, there has been a growth in the demand for increasingly smaller quantities of packaging, as well as for samples ever closer to the quality of the final product. Usually this is referred to as short runs, i.e., productions of batches up to five thousand pieces, and micro runs, i.e., productions ranging from the single piece to batches in the order of a few hundred pieces.

Laser cutting machines are typically used to produce short runs of packaging, such as cardboard boxes. Laser cutting machines according to the prior art are described, for example, in international patent application numbers WO 2014/045271 A1 and WO 2020/025771 A1.

Flatbed plotters are typically used to produce micro runs of packaging; these comprise a work surface and a tool-holder head movable in a controlled manner on the work surface. The tool-holder head comprises a cutting blade and a male creasing tool, which typically consists of a thin rounded bar, that presses on the surface of the sheet of cardboard, so as to obtain the desired folding lines.

To improve the definition of the folding lines, in particular if flat sheets of cardboard are used, and simultaneously prevent breakage of the surface of the sheet of cardboard, resulting in poor quality of the crease and hence of the finished product, the creasing tool is preferably coupled with corresponding channels, or female creasing elements, having a greater depth than the thickness of the sheet of cardboard and inside which the cardboard is thrust by the creasing tool.

A flatbed plotter according to the prior art is described, for example, in the German patent application no. DE 10 2012 002 100 A1. This flatbed plotter comprises a work surface and a tool station mounted on the work surface and movable with respect thereto. A support, preferably rectangular in shape, for a sheet of cardboard to be cut and creased is fixed to the work surface, for example glued by means of adhesive strips. One or more creasing channels, which form the female creasing elements, are positioned on the support, for example fixed by means of a respective adhesive strip, according to a pre-set creasing model and a creasing wheel, i.e., the male creasing tool, mounted on the tool-holder station, moves inside the creasing channels to plot one or more folding lines on the sheet of cardboard.

Although a flatbed plotter is effective for micro runs of cardboard boxes, it has the drawback of not guaranteeing precise coupling between the creasing tool and the corresponding channel. This results in possible imprecisions in the folding lines obtained and hence poor quality of the crease, and in any case a lengthy production process of the packaging involving several manual operations, making its use somewhat impractical.

Moreover, particular attention must be paid to the processing depths, which change both depending on the material of the support and on the material to be processed. Also in this case, the result is a difficult automation of the production process of the packaging.

### BRIEF SUMMARY

One object of the present disclosure is to provide a plotter for creasing and cutting packaging material, which solves the aforesaid drawbacks associated with prior art cutting plotters in a simple and effective manner.

More particularly, an object of the present disclosure is to provide a plotter for creasing and cutting sheets of packaging material, and a related unit and creasing method, such as to produce a high quality and precise creasing of the packaging being processed.

Yet another object of the present disclosure is to provide a plotter for creasing and cutting sheets of packaging material, and related unit and creasing method, such as to increase the degree of automation of the production process of the packaging.

Not least object of the present disclosure is to provide a creasing unit, which can be produced at limited costs and is applicable to any known flatbed cutting plotter.

An invention concerns, in a first aspect thereof, a plotter for creasing and cutting a sheet of packaging material. The plotter comprises a work surface and a tool-holder head movable on the work surface according to a pre-set creasing pattern and a pre-set cutting pattern.

The plotter is characterized in that it comprises a creasing unit, configured to be mounted on the tool-holder head. The creasing unit includes an extruder, configured to extrude at least one profile onto the work surface according to the pre-set creasing pattern, and a creasing tool provided with a groove adapted to couple, in use, with the at least one profile extruded by the extruder thereby obtaining a corresponding folding line on the sheet of packaging material.

Due to this combination of features, it is possible to obtain precise and high-quality creasing of the sheet of packaging material being processed. In fact, the presence of the extruder allows the creasing profiles to be extruded in a precise position onto the work surface and the subsequent passage, on the extruded creasing profiles, of the creasing tool provided with a groove for coupling with the extruded creasing profiles, allows precise and high-quality creasing to be achieved.

In other words, with respect to the prior art plotters described above, in the invention there is an inversion between male and female creasing elements, i.e., the creasing channels (female creasing elements according to the prior art) are replaced by extruded profiles (male creasing elements) and the creasing wheel (male creasing element according to the prior art) is provided with a groove (female creasing element). The aforesaid inversion between male and female creasing elements allows the step of extruding the profiles onto the work surface to be simplified and a folding line that is precise both in width and in depth to be simultaneously obtained, making it no longer necessary to pay attention to vertical position of the creasing tool, which will rest on the extruded profiles, and in any case ensuring correct yielding of the material to be creased.

In a second aspect thereof, the invention relates to a creasing unit characterized in that it comprises an extruder, configured to extrude at least one profile according to a pre-set creasing pattern, and a creasing tool provided with a groove adapted to couple, in use, with the at least one profile extruded by the extruder, thereby obtaining a corresponding folding line on a sheet of packaging material.

In a third aspect thereof, the invention relates to a creasing method conducted with a plotter for cutting and creasing a sheet of packaging material, the method comprising the following steps:
using an extruder of a creasing unit of the plotter, extruding onto a work surface of the plotter at least one profile according to a pre-set creasing pattern;
placing a sheet of packaging material on the work surface, immediately above the at least one extruded profile; and
sliding, according to the pre-set creasing pattern, a creasing tool of the creasing unit of the plotter on the at least one extruded profile, so that a groove of the creasing tool couples with each extruded profile, thereby obtaining a corresponding folding line.

### BRIEF DESCRIPTION OF THE DRAWINGS

Further features and advantages of the present invention will be more apparent from the detailed description of preferred embodiments thereof, provided below by way of non-limiting example, with reference to the accompanying drawings. In the drawings:

FIG. 1 is a perspective view of a plotter for creasing and cutting a sheet of packaging material according to the present invention, subsequently to a step of extruding a plurality of creasing profiles according to a pre-set creasing pattern;

FIG. 2 is a perspective view of the plotter of FIG. 1 subsequently to a step of creasing the sheet of packaging material according to the pre-set creasing pattern;

FIG. 3 is a partial perspective view of a tool-holder head of a plotter, standing by to receive an extruder or a creasing tool of a creasing unit according to the present invention;

FIG. 4 is a perspective view of an extruder of the creasing unit, to be mounted on the tool-holder head of FIG. 3;

FIG. 5 is a perspective view of a creasing tool of the creasing unit, to be mounted on the tool-holder head of FIG. 3; and

FIG. 6 is a partially exploded perspective view of the creasing tool of FIG. 5.

### DETAILED DESCRIPTION

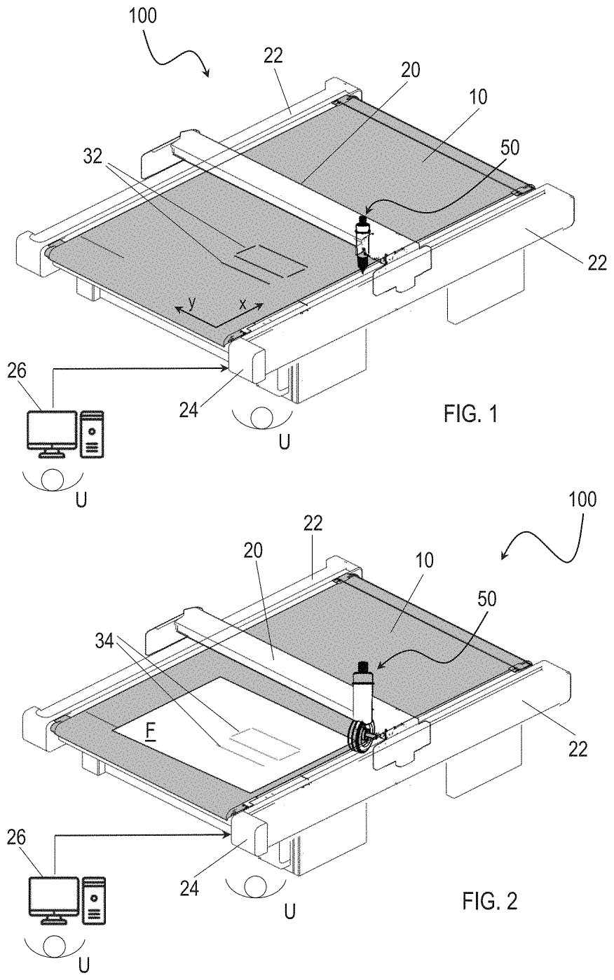

With reference to FIGS. 1 and 2, a plotter for creasing and cutting a sheet of packaging material according to a preferred embodiment of the present invention is illustrated therein.

The plotter, indicated in general with the reference number 100, comprises a work surface 10, which acts as creasing surface and as cutting surface of a sheet F of packaging material, preferably a sheet of flat or corrugated cardboard.

The sheet F is fixed to the work surface 10 in a known way, for example by gluing with adhesive or using a suction system placed under the work surface 10.

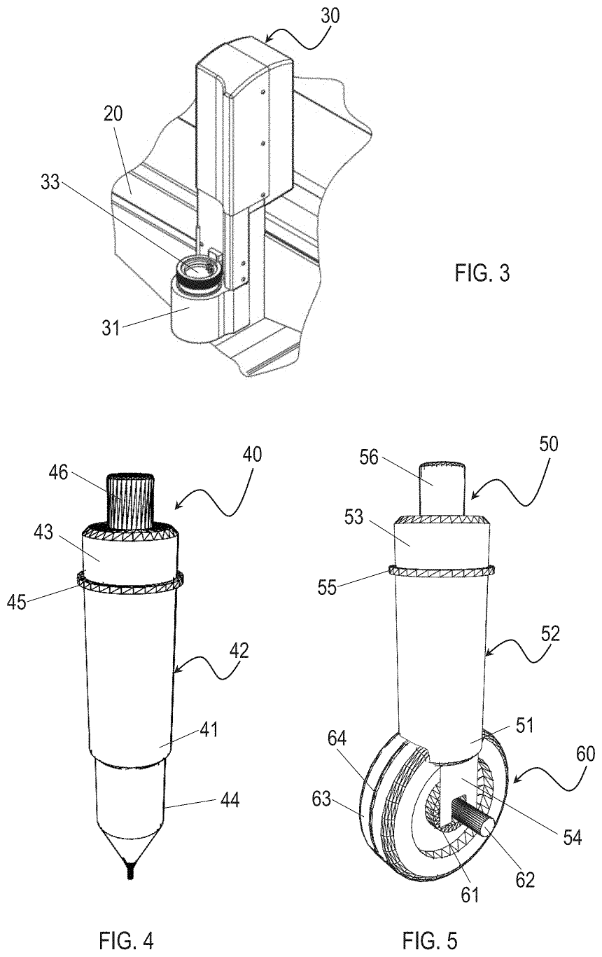

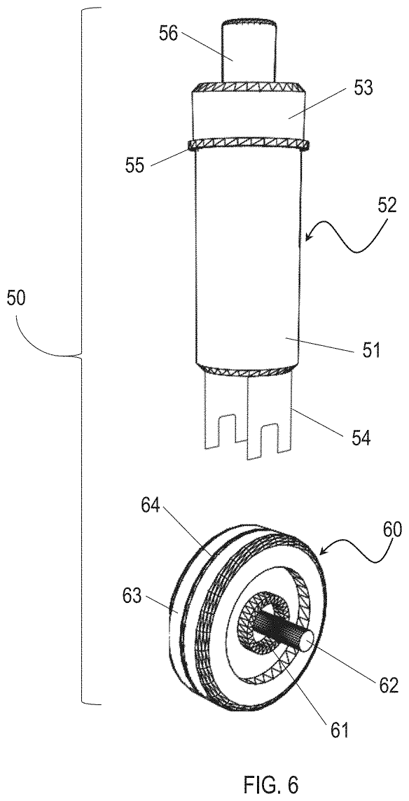

The plotter 100 comprises a crossbar 20, which is mounted on the work surface 10 sliding along a pair of longitudinal guides 22. A tool-holder head 30 (shown in FIG. 3) is mounted on the crossbar 20, and is therefore movable with the crossbar 20 according to an axis x and, along the crossbar 20, according to an axis y orthogonal to the axis x. The tool-holder head 30 can be moved according to a third axis (not shown), orthogonal to the axes x and y and can also be rotated.

As shown in detail in FIG. 3, the tool-holder head 30 comprises a tool support 31, provided with a through hole 33 for insertion of an extruder 40 (shown in FIG. 4) or of a creasing tool 50 (shown in FIG. 5), which together form a creasing unit.

A single tool support 31 can be provided in the tool-holder head 30, as shown in FIG. 3, or, alternatively, two separate supports can be provided, i.e., one support for the extruder 40 and one support for the creasing tool 50.

In particular, and as will be described in more detail in the following, the extruder 40 and the creasing tool 50 are mounted in the tool support 31, or in the respective tool support if one support is provided for each tool, of the tool-holder head 30, respectively to extrude, onto the work surface 10, one or more profiles 32 (visible in FIG. 1) according to a pre-set extruding pattern and to produce corresponding folding lines 34 (visible in FIG. 2) on the sheet F of packaging material arranged on the work surface 10 immediately above the profiles 32.

The creasing pattern can be entered manually by a user U via a graphic interface 24 of the plotter 100 or, alternatively, can be set by the user U on a personal computer 26, positioned in proximity of the plotter 100, or in a remote position with respect to the plotter 100, and transmitted, by cable or wireless, to the plotter 100.

As shown in detail in FIG. 4, the extruder 40 of the creasing unit comprises a main body 42, preferably substantially cylindrical, which has a nozzle 44 at the proximal end 41 thereof, i.e., an end that, in use, is close to the work surface 10, and a shank 46 at the distal end 43 thereof i.e., an end that, in use, is at a distance from the work surface 10, wherein a wire made of plastic material, for example polylactic acid (PLA), acrylonitrile-butadiene-styrene (ABS) and glycol modified polyethylene terephthalate (PET-G), passes through the shank to be extruded by the nozzle 44.

In the main body 42, preferably in proximity of the shank 46, an annular relief 45 is also obtained, the function of which is that of allowing the extruder 40 to be mounted in the tool support 31 of the tool-holder head 30. In particular, the extruder 40 is inserted from above, inside the through hole 33 obtained in the tool support 31, until the annular relief 45 forms an interlocking coupling with a corresponding groove (not shown) obtained on an internal surface of the tool support 31. In mounted position, the nozzle 44 of the extruder 40 protrudes from the bottom of the tool support 31.

With reference to FIG. 5, the creasing tool 50 comprises a main body 52, which has a proximal end 51, i.e., an end that, in use, is close to the work surface 10, and a distal end, i.e., an end that, in use, is at a distance from the work surface 10. A fork 54 extends from the proximal end 51 of the main body 52, while a shank 56 extends from the distal end 53.

The creasing tool 50 further comprises a wheel 60, provided with a hub 61 for the passage of a rolling pin 62. In particular, the rolling pin 62 is adapted to be interlocked in the fork 54 extending from the main body 52, so as to allow rotating coupling between wheel 60 and main body 52 of the creasing tool 50.

Moreover, an annular relief is obtained in the main body 52, preferably in proximity of the shank 56, the function of which is to allow mounting of the creasing tool 50 in the tool support 31 of the tool-holder head 30. In particular, the main body 52 of the creasing tool 50 is inserted from above, inside the through hole 33 provided in the tool support 31, until the annular relief 55 forms an interlocking coupling with a corresponding groove (not shown) obtained on an inner surface of the tool support 31. In this inserted position, the proximal end 51 of the main body 52, and the fork 54 extending therefrom, protrude from the bottom of the tool support 31. Subsequently, the wheel 60 is rotatably and detachably fastened to the main body 52, by interlocking of the respective pin 62 in the fork 54 of the main body 52. The detachable interlocking coupling between main body 52 and wheel 60 of the creasing tool 50 allows easy and immediate replacement of the wheel 60 when the depth or width of the folding lines to be obtained varies.

Moreover, the wheel 60 has a band 63, intended to roll on the work surface 10, on which a circumferential groove 64 is obtained, which, when the creasing tool 50 is in use, is adapted to couple with each profile 32 extruded by the extruder 40 onto the work surface 10, thereby obtaining the folding lines 34. The circumferential groove 64 is preferably obtained centrally in the rolling band 63. The rolling band 63 is made of plastic material, for example nylon, or of metal, for example aluminium.

The size of the main body 42 and 52, respectively of the extruder 40 and of the creasing tool 50, varies as a function of the size of the through hole 33 of the tool support 31 of the tool-holder head 30 into which the extruder 40 and the creasing tool 50 must be inserted. Moreover, the system for mounting the extruder 40 and the creasing tool 50 in the tool-holder head 30 can also vary as a function of the model of plotter on which they must be installed.

The plotter 100 further comprises a blade (not shown) for cutting the sheet F according to a pre-set cutting pattern. The blade can be of tangential or oscillating type and is mounted on the tool-holder head 30 and moved on the work surface 10 according to the pre-set cutting pattern.

Similarly with respect to the creasing pattern, the cutting pattern can be entered manually by the user U via the graphic interface 24 of the plotter 100 or, alternatively, can be set by the user U on the computer 26, placed in proximity of the plotter 100, or in a remote position with respect to the plotter 100, and transmitted, by cable or wireless, to the plotter 100.

With reference to FIGS. 1 and 2, a creasing method, conducted using the plotter 100 described above, is now described.

The method comprises a preliminary step of setting a creasing pattern. The creasing pattern can be entered manually by the user U using the interface 24 of the plotter 100. Alternatively, the creasing pattern can be set on a personal computer 26, in proximity of or in a remote position with respect to the plotter 100, and transmitted to the plotter by cable or wireless.

The step of setting the creasing pattern is followed by a step of extruding one or more profiles 32. To this end, the extruder 40 of the creasing unit is loaded, manually or automatically, into the tool support 31 of the tool-holder head 30 and the profiles 32 are extruded through the nozzle 44.

The step of extruding is followed by a step of loading the sheet F of packaging material to be creased onto the work surface 10 and immediately above the extruded profiles 32.

The step of loading the sheet F is followed by a step of creasing a number of folding lines 34 equal to the number of profiles 32 previously extruded. For this purpose, the creasing tool 50 of the creasing unit is loaded, manually or automatically, into the tool support 31 of the tool-holder head 30 and slides on the sheet F of packaging material according to the pre-set creasing pattern. In particular, during this movement the groove 64 formed in the wheel 60 of the creasing tool 50 couples with each profile 32 extruded onto the work surface 10, thereby compressing the sheet F between groove 64 and profile 32 and obtaining the corresponding folding line 34.

The step of creasing is followed by the step of cutting the sheet F. For this purpose, the blade is loaded onto the tool-holder head 30 and moved on the sheet F according to the pre-set cutting pattern.

From the description above, the features of the cutting plotter, of the creasing unit and of the creasing method of the present invention are evident, as are the related advantages. In particular, the plotter and the related unit and creasing method, are such as to produce high quality and precise creasing of the packaging being processed. Moreover, the plotter and the related unit and creasing method, are such as to increase the degree of automation of the production process of the packaging. Furthermore, the creasing unit has a simple structure and can therefore be produced at limited costs. Finally, the creasing unit is applicable to any known flatbed plotter.

Finally, it is clear that the cutting plotter and the related creasing unit thus conceived are susceptible to numerous modifications and variants; moreover, all the details can be replaced by equivalent technical elements.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A plotter for creasing and cutting a sheet of packaging material, the plotter comprising:
a work surface;
a tool-holder head movable on the work surface according to a pre-set creasing pattern and a pre-set cutting pattern; and
a creasing unit configured to be mounted on the tool-holder head, the creasing unit comprising:
an extruder configured to extrude at least one profile onto the work surface according to the pre-set creasing pattern; and
a creasing tool provided with a groove adapted to couple, in use, with the at least one profile extruded by the extruder, wherein a corresponding folding line is obtained on the sheet of packaging material.

2. The plotter of claim 1, wherein the extruder comprises a main body, which has a nozzle at a proximal end thereof.

3. The plotter of claim 1, wherein the creasing tool comprises a main body which has at a proximal end thereof a wheel, which comprises a rolling band on which the groove is obtained.

4. The plotter of claim 3, wherein the groove is obtained centrally in the rolling band.

5. The plotter of claim 3, wherein the wheel is rotatably and detachably fastened to the main body of the creasing tool by interlocking coupling of a rolling pin with a fork, which extends from the proximal end of the main body.

6. The plotter of claim 2, wherein, at a distal end of the main body of the extruder and/or of the creasing tool, an annular relief is obtained for interlocking coupling in a tool support of the tool-holder head.

7. A creasing unit comprising:
an extruder configured to extrude at least one profile according to a pre-set creasing pattern; and
a creasing tool provided with a groove adapted to couple, in use, with the at least one profile extruded by the extruder,
wherein a corresponding folding line is formed on a sheet of packaging material.

8. The creasing unit of claim 7, wherein the extruder comprises a main body, which has a nozzle at a proximal end thereof.

9. The creasing unit of claim 7, wherein the creasing tool comprises a main body which has, at a proximal end thereof, a wheel which comprises a rolling band on which the groove is obtained.

10. The creasing unit of claim 9, wherein the groove is obtained centrally in the rolling band.

11. The creasing unit of claim 9, wherein the wheel is rotatably and detachably fastened to the main body of the creasing tool by interlocking coupling of a rolling pin with a fork, which extends from the proximal end of the main body.

12. The creasing unit of claim 7, wherein, at a distal end of the main body of the extruder and/or of the creasing tool, an annular relief is obtained for interlocking coupling in a tool support of the tool-holder head.

13. A method of creasing a sheet of packaging material, wherein the method is conducted with a plotter comprising a work surface, a tool-holder head movable on the work surface according to a pre-set creasing pattern and a pre-set cutting pattern, and a creasing unit configured to be mounted on the tool-holder head, the method comprising the following steps:
using an extruder of the creasing unit, extruding onto the work surface of the plotter at least one profile according to the pre-set creasing pattern;
placing a sheet of packaging material on the work surface, immediately above the at least one extruded profile; and
sliding, according to the pre-set creasing pattern, a creasing tool of the creasing unit on the at least one extruded profile, so that a groove of the creasing tool couples with each extruded profile, thereby obtaining a corresponding folding line.
